(19) United States
(12) Patent Application Publication
(10) Pub. No.: US 2020/0360996 A1
(43) Pub. Date: Nov. 19, 2020

(54) METHOD FOR METAL INJECTION MOLDING

(71) Applicant: FRAUNHOFER-GESELLSCHAFT ZUR FOERDERUNG DER ANGEWANDTEN FORSCHUNG E.V., MUNICH (DE)

(72) Inventors: FRANZ-JOSEF WOESTMANN, MUENSTER (DE); LUTZ KRAMER, OSTERHOLZ-SCHARMBECK (DE); MICHAEL HEUSER, BREMEN (DE); SEBASTIAN BORIS HEIN, BREMEN (DE); THOMAS HARTWIG, RITTERHUDE (DE); MARCO MULSER, BREMEN (DE)

(73) Assignee: FRAUNHOFER-GESELLSCHAFT ZUR FOERDERUNG DER ANGEWANDTEN FORSCHUNG E.V., MUNICH (DE)

(21) Appl. No.: 16/961,313

(22) PCT Filed: Jan. 9, 2019
(86) PCT No.: PCT/EP2019/050456

§ 371 Date: Jul. 10, 2020

(30) Foreign Application Priority Data
Jan. 12, 2018 (DE) 10 2018 200 508.7
Jan. 12, 2018 (DE) 10 2018 200 509.5

(51) Int. Cl. B22F 3/22; B33Y 70/00; B22F 7/08; B22F 3/10

(52) U.S. Cl. CPC B22F 3/225; B33Y 70/00; B33Y 80/00; B22F 3/10; B22F 7/08

(57) ABSTRACT

One method for producing a cast body is described. The method may have one step for producing one or more insert parts. The one or more insert parts are provided in a casting mold of an injection molding tool such that a cavity corresponding to the shape of the cast body is formed by the one or more insert parts or by the one or more insert parts together with the casting mold. The cavity is filled with a molding compound containing a powder of a sinterable material. A green part may be produced by solidifying the molding compound. An intermediate product may be removed from the injection molding tool where the intermediate part may have the green part and the one or more insert parts. The one or more insert parts may be removed from the intermediate product. Further, the green part may be debinded and sintered.

The application relates to a method for metal injection molding, for producing metallic molded parts having complex geometries, and to a method for producing metallic spirals.

According to the prior art, typically injection molding tools are used during metal injection molding, or “MIM” for short, in which, by way of segmented cavities, slides or core parts, the shaping of complex molded parts is achieved. This technology, however, cannot be used to achieve arbitrarily complex geometries since the molded part has to be demolded by opening the tool and pulling the cores.

It is the object of the application to produce complex metallic molded parts in a metal injection molding process. This object is achieved by a method according to claim 1. Possible embodiments will be apparent from the dependent claims as well as from the description and the figures.

The present application accordingly proposes a method for producing molded parts having complex geometries, in which one or more insert parts are provided in a mold of an injection molding tool, so that a cavity corresponding to the shape of the molded part is formed by the one or more insert parts, or is formed by the one or more insert parts together with the mold.

For this purpose, a powder-filled molding compound is produced, which comprises a binder, for example an organic binder, and a powder made of a sinterable material, so as to produce a sintered molded part. For example, it is possible to use metal powders to produce a metallic molded part, and in particular copper powder, aluminum powder, steel powder, titanium powder and/or noble metal powder, such as platinum powder, can be used. In one embodiment, high purity copper powder can be used. In order to produce molded parts from alloyed materials, it is also possible to use powders made of metal alloys, such as aluminum alloys. In order to produce molded parts from alloyed materials, it is possible to use prealloyed powders, or a blend of elemental powders can be provided. In another embodiment, it is also possible to use a master alloy, to which one or more elemental powders are added.

The application also relates to a method for producing metallic spirals. This method can also be used in a manner that is separate from the aforementioned method, in which the one or more insert parts are provided. The applicant reserves the right to also claim protection for the method for producing spirals separately from the remaining features of the proposed method for producing molded parts having complex geometries, that is, in particular without the insert parts described there. The two methods are combined in possible embodiments.

According to the prior art, metallic spirals, such as coils or springs, are produced by winding wire, such as round wire or profiled wire. In industrial manufacturing, the winding process is automated, in particular for simple spirals and for large volumes, and is carried out on special winding machines. However, automated winding systems can only be used with limitations for small delicate coils, coils having a high fill ratio or in the case of special requirements with regard to the stiffness, for example, resulting in high complexity and high costs during production.

In order to produce a metallic spiral in the method according to the application, a spiral-shaped cavity is provided in an injection molding tool.

The cavity is filled with a molding compound containing a powder made of a sinterable material. By solidifying of the molding compound, a green body is produced, which is subsequently removed from the injection molding tool. The green body is subsequently debound and sintered.

By producing the spirals as molded bodies in an injection molding process, increased flexibility can be achieved with respect to the spiral geometry. The flexibility is increased even further by the potential use of insert parts.

The spiral-shaped cavity can be formed by a mold of the injection molding tool. However, it may also be formed by one or more insert parts that are provided in the mold, or by one or more insert parts together with the mold of the injection molding tool. These may be, in particular, the aforementioned insert parts having the properties described in the present application.

In order to produce the spirals, a powder-filled molding compound is produced, which comprises a binder, for example an organic binder, and a powder made of a sinterable material, so as to produce a sintered molded part. For example, it is possible to use metal powders to produce a metallic molded part, and in particular copper powder, aluminum powder, steel powder, titanium powder and/or noble metal powder, such as platinum powder, can be used. In one embodiment, high purity copper powder can be used. In order to produce molded parts from alloyed materials, it is also possible to use powders made of metal alloys, such as aluminum alloys. In order to produce molded parts from alloyed materials, it is possible to use prealloyed powders, or a blend of elemental powders can be provided. In another embodiment, it is also possible to use a master alloy, to which one or more elemental powders are added.

Advantageously, the embodiments described hereafter can optionally be used in connection with all methods described in the application.

In one embodiment, powder blends made of metallic and ceramic powders are used, so as to produce metal-ceramic structures.

In one embodiment, the organic binders comprise at least one thermoplastic polymer. In one embodiment, the organic binders can furthermore comprise a plasticizer, which can be deliberately dissolved out, and/or a second polymer, which can be deliberately decomposed. For example, the second polymer can be thermally or catalytically decomposable.

In different embodiments, the organic binders can furthermore contain additional components, such as surfactants, phase compatibilizers, wetting agents, oligomers, short-chain polymers and/or other further plasticizers. In different embodiments, the composition of the organic binders depends on the composition of the powder so as to avoid a chemical reaction of the binder with the powder and, for example, to effectuate wetting adequate for the powder.

Different material properties, such as a particular conductivity, can be achieved as a result of the composition of the molding compound.

In one embodiment, the molding compound can, for example, comprise a steel powder, for example for producing steel springs. In one embodiment, the molding compound can also comprise a copper powder, for example made up of highly conductive copper, for example for producing copper coils.

The powder-filled molding compound is mixed, for example, and thereafter homogenized preferably under high shearing forces. This can take place through the use of a shear roller or an extruder, for example through the use of a twin-screw extruder. The mixing and/or the homogenization of the molding compound, however, can also take place by way of kneading or by way of a combination of kneading and extrusion.

In one step of the method, the cavity is filled with the metal powder-filled molding compound by injecting the molding compound into the cavity. In one embodiment, the injected molding compound has a temperature of at least 50° C., preferably at least 100° C., and particularly preferably at least 120° C., and a temperature of no more than 300° C., preferably no more than 250° C., and particularly preferably no more than 200° C.

Thereafter, a green body is produced by solidification of the molding compound. The solidification of the molding compound typically takes place by cooling of the molding compound. Together with the one or more insert parts, the green body forms an intermediate product. The intermediate product is removed from the injection molding tool.

The one or more insert parts are removed in a subsequent step. The insert parts are typically destroyed in the process.

In one step, the binder is removed by debinding the green body, for example by way of chemical, catalytic and/or thermal debinding.

In one step, the molded part is densified by sintering, wherein the molded part may be given the desired net shape thereof.

In one embodiment, first the one or more insert parts are removed, and thereafter the green body is debound and sintered. If no insert parts are present, the green body is removed, in one embodiment, from the cavity of the injection molding tool, and if necessary, post-processed, debound and sintered.

In one embodiment, the removal and the debinding are carried out in the same step. In one embodiment, the one or more insert parts can be removed during a thermal debinding process by way of burning out.

In one embodiment, the green body is mechanically rinsed, in a step downstream of the removal of the one or more insert parts, so as to remove residues of the one insert part or of the multiple insert parts from the green body.

In one embodiment, the green body is mechanically post-processed, prior to or after the removal of the one or more insert parts, preferably, however, prior to sintering. This allows burrs, gate structures or other undesirable parts of the green body to be mechanically removed from the green body while it is still relatively easy to process, or a surface of the green body to be processed. This enables an economical removal of burrs or edges, for example, as well as post-processing, and a long tool life and even a greater tolerance in the production of the tool as well as the manufacture of the insert parts can be achieved. The removal of the burrs or of the gate structures, or of the other undesirable parts, can be carried out in an automated manner or manually, for example by way of a knife, a carpet cutter or a scalpel.

The insert parts are preferably designed for use in a method according to the application so as not to deform under the pressure of the injected molding compound and as a result of the heat input of the injected molding compound. One difficulty is thus to provide insert parts that are able to withstand the mechanical and thermal loads, while being removable.

The insert parts can be subjected to material testing for this purpose. The insert parts can be made of water-soluble substances or substances decomposable by aqueous media.

For this purpose, insert parts can be produced from a thermoset polymer, and in particular a thermoset polymer having hydrolytically cleavable functionalities, such as esters, anhydrides or carbamates.

The insert parts can also be produced from a thermoplastic composite, such as a composite containing water-soluble materials. In particular, a water-soluble thermoplastic polymer having particulate inclusions, such as inclusions of ceramic particles or salt particles, can be used.

In another embodiment, it is also possible to use insert parts made of salt, or of metals or metal alloys having a low melting point.

It is also possible to use insert parts made of a thermoplastic polymer, such as PMMA, or insert parts made of a composite comprising such a thermoplastic polymer.

The insert parts can be produced, for example, by way of molding, injection molding or reaction injection molding. The insert parts can also be produced in rolling processes or by way of forming processes. The insert parts can also be produced in an additive manufacturing process, such as by way of stereolithography, direct light processing or digital light processing, selective laser sintering, selective laser melting, fused deposition modeling or fused filament fabrication, multijet modeling, binder jetting or laminated object molding. The insert parts can also be produced or post-processed by way of subtractive manufacturing processes, such as machining or milling.

In some embodiments, insert parts made of materials that can be chemically removed are advantageously used, such as by dissolution in a solvent or by way of chemical cleavage of the polymers and dissolution of the decomposition products.

The production process for the insert parts can be adapted in accordance with the requirements with regard to the insert part. For example, reactive substance mixtures or thermoplastic materials can be used in possible production processes. In both instances, the production can advantageously be carried out in an additive process.

In some embodiments, in particular when the insert parts are made of reactive substance mixtures, the insert parts can be chemically removed. This can be carried out, for example, by way of dissolution in a suitable solvent or by way of chemical cleavage of the polymers and dissolution of the decomposition products. This can be advantageous, in particular, in the case of large molded parts or high wall thicknesses since the chemical removal processes can be controlled so that damage of the molded part due to gases being released too quickly can be avoided. In possible embodiments, the insert parts, however, can also be thermally removed.

For example, the insert parts can be produced by way of selective laser sintering, selective laser melting, fused deposition modeling or fused filament fabrication. It shall be noted that the expression “selective laser melting” is primarily known from metal processing. The method can, however, also be used to produce the insert parts shown here, having the described properties. Thermoplastic materials can be used with these methods, for example, of which the insert parts are additively produced. Depending on the material, the insert parts can be chemically soluble or insoluble. For example, materials can be used that are soluble in acetone, such as acrylonitrile butadiene styrene (ABS), polyethylene terephthalate (PET) or polylactide (PLA). It is also possible to use water-soluble polymers, for example polyvinyl acetate (PVA), which is frequently used as a soluble support structure in filament printing. It is also possible to use insoluble polymers that can only be expelled thermally, such as polyamide (PA) or polypropylene (PP).

For example, the insert parts can also be produced in a light-based additive manufacturing process, such as by way of stereolithography, direct light processing, digital light processing or multijet modeling. This method uses reactive materials, for example, known as resins, which cross-link as a result of a light-induced chemical reaction. These methods are preferred with respect to the achievable accuracies of the prints since the dissolution of light-based methods is typically greater than that of the additive processes mentioned above. Acrylates are used as reactive materials, for example, but epoxies may also be utilized. The insert parts thus formed are typically composed of three-dimensionally cross-linked polymers, which are typically not soluble and are therefore removed by way of thermal decomposition or chemical cleavage.

As a result of the use of cleavable chemical functions (such as the anhydrides, esters, carbamates mentioned above), the three-dimensional networks of the three-dimensionally cross-linked polymers can be broken down into small, molecular compounds, which can then go into solution. Aqueous, basic media are preferably used to remove the insert parts, which, for example in the case of esters, result in saponification, and cause hydrolytic cleavage in the anhydrides. Cleaving of carbamates is likewise not precluded within the meaning of the present application. In possible embodiments of the described method, the deliberate cleavage of the functional groups results in chemical degradation of the insert part and the removal thereof from the combination with the feedstock.

One advantage of the described removal of the insert parts by way of chemical cleavage is that a swelling of the insert parts can be avoided. In this way, the risk of cracking in the feedstock, and thus damage to the feedstock part due to mechanical warpage, is low.

As mentioned above, the insert parts can also be produced by way of binder jetting. A binder is printed into a powder bed, so as to bind powder particles there within the desired geometric shape. In the case of polymers, for example, thermoplastic powders are used. The used binders are, for example, solvents for the polymer type or reactive systems that develop adhesive action between the powder grains as a result of a curing step. In one embodiment, the adhesion caused by the binder between the powder particles can be overcome in a chemical process, similarly to the reactive materials, so as to remove the insert parts. This means that the binder is dissolved, for example, using a suitable solvent, or is chemically cleaved in a suitable liquid medium. The loose powder particles can then be rinsed out. A particular advantage in this case is that comparatively little material has to be chemically cleaved. Compared to processes in which solid materials are used, the process thus distinguishes itself by its speed. It is also possible, however, to use soluble materials in the case of insert parts produced by way of binder jetting, which are then dissolved for removal.

Moreover, several insert parts can be produced by identical or different of the above-described methods, and can be detachably or non-detachably connected to one another, for example joined to form a single insert part. Taken together, and, if necessary, together with the mold of the injection molding tool, the insert parts then delimit the cavity.

In one embodiment, insert parts are produced as individual parts in additive methods so as to avoid combining multiple insert parts, and enhance the economic efficiency of the method.

Exceptional flexibility in the production of the molded parts is achieved as a result of the different possible manufacturing methods for the insert parts, and the combination of these manufacturing methods. It is even possible to achieve complex geometries, for example geometries having undercuts, through-holes, channels or openings. In addition, different materials can be used, which can be removed in different ways.

The insert parts can be designed in such a way that the mold of the injection molding tool used, in which the insert parts are inserted, partially contribute to the shape of the molded part, for example by the mold predefining the outer delimitation or also predefining other parts of the shape. The insert parts, however, can also be configured in such a way that the mold of the injection molding tool has no influence whatsoever on the shape of the molded part, but that the shape is only determined by the insert parts.

For example, the insert parts are configured in such a way that the outer delimitation thereof is adapted to the mold of the injection molding tool. In one embodiment, a contact between the molding compound and the injection molding tool is avoided to avoid adhesions of the molding compound to the injection molding tool.

The insert parts and/or the mold include regions or openings in or through which the molding compound can be injected into the cavity.

The above-described manufacturing methods for the insert parts and the use of the insert parts in injection molding tools, which do not need to have any particular shape, allow small and pilot series to be economically manufactured in low volumes.

The one or more insert parts can be removed by placing the intermediate product in an aqueous medium so as to dissolve the one or more insert parts. However, the one or more insert parts can also be decomposed by way of catalysis based on an acid or a base, or by way of hydrolysis. In another embodiment, the one or more insert parts can be removed by way of burning out.

In one embodiment, the insert part undergoes, or the insert parts undergo, swelling during the dissolution process, and an elastic binder is used for the powder-filled molding compound, which tolerates the deformation of the insert part, or of the insert parts, and returns to the original shape thereof after the insert part has been removed.

In one embodiment, as mentioned above, spirals, that is, spiral-shaped bodies, such as coils or springs, are produced in the method, by configuring the one or more insert parts in such a way that the one or more insert parts and, if necessary, the injection molding tool in which the insert parts are arranged, predefines a spiral-shaped cavity. In this way, it is possible to produce spirals having arbitrary cross-sectional geometries or variable cross-sections, which cannot be produced by way of winding. In particular, it is possible to produce spirals having non-round winding profiles.

The cavity that is filled with the molding compound and predefines the shape of the desired spiral-shaped molded body can have a complex geometry. Several examples of such complex geometries are listed hereafter. These may be combined with one another. Other geometries are additionally possible and will be obvious to a person skilled in the art from the intended use of the spiral.

Coil parameters or spiral parameters, such as the pitch and the number of turns per length, can be set deliberately by an appropriately shaped cavity.

An inner hollow space delimited by the spiral, or by the turns of the spiral, can have a complex cross-sectional surface in a plane orthogonal to a longitudinal direction of the spiral. In particular, the inner hollow space can have a cross-sectional surface that is not achievable, or only difficult to achieve, by winding. The inner hollow space delimited by the turns of the molded spiral can have a round or a non-round cross-sectional surface and/or a cross-sectional surface that is variable along the longitudinal direction of the spiral. The cross-sectional surface can have a constant or variable radius, or a constant or variable side length, and, for example, be round, oval, rectangular or polygonal.

The outer spiral dimensions in the plane orthogonal to the longitudinal direction can likewise be set by way of the described method. The outer spiral dimensions can have a round, an oval or a rectangular shape, for example. In the plane orthogonal to the longitudinal direction, an extent of the spiral can be, for example, between 0.5 cm×0.5 cm and 10 cm×10 cm. For example, a rectangular spiral can have outer dimension of between 1 cm×3 cm and 3 cm×8 cm. Larger and smaller dimensions in both spatial directions are likewise possible.

The metallic spiral can moreover have a complex winding cross-sectional profile. The winding cross-sectional profile denotes the cross-section of the material itself, corresponding to the wire cross-section of a wire used, for example, for wound coils. The winding cross-sectional profile can be rectangular, for example, which would make winding more difficult or impossible, but does not have any adverse effect on the manufacture of the spiral in the method proposed here. The winding cross-sectional profile can also be polygonal or oval, have notches and/or indentations and/or be variable along the length thereof. A pitch of the spiral and/or a winding direction of the spiral can be variable along the longitudinal direction.

As a result of the proposed production of the spiral, the described, potentially variable, complex winding cross-sections or surface cross-sections of the inner hollow space, the potentially variable outer spiral dimensions and the potentially variable coil parameters can be present in combination. For example, a rectangular winding cross-sectional profile having a side length that is variable along the spiral, and having an angled progression and a variable pitch along the longitudinal direction of the coil, can be implemented.

In order to set a desired spring stiffness, certain materials or alloys may be selected, for example, for the metal powder, and the desired pitch or winding thickness or winding cross-sectional geometry of the spring can be set.

Coils or spirals produced by way of the proposed method can have winding thicknesses between 0.1 mm and 2 mm, for example.

In one embodiment, spirals having wall thicknesses of less than 200 μm, and preferably of less than 150 μm, are produced.

A fill factor of the coils produced in this way is, for example, more than 65%, preferably more than 75%, and particularly preferably more than 85%. In one embodiment, the fill factor is more than 90%, for example 95%.

In one embodiment, the insert parts comprise, for example, handles, indentations, recesses or other geometries, which do not contribute to the shape of the cavity and simplify handling of the intermediate product. For example, the intermediate product can be gripped by way of such a handle or such a geometry by hand, or with the aid of a tool, and be moved.

The method according to the application allows molded bodies having different geometries to be produced by manufacturing different insert parts, which can be inserted in the same injection molding tool. The insert parts can be manufactured in such a way that the cavities thereof have different progressions, but the outer contour thereof is the same, so that the different insert parts have room in the injection molding tool.

Exemplary embodiments are shown in the figures. In the drawings:

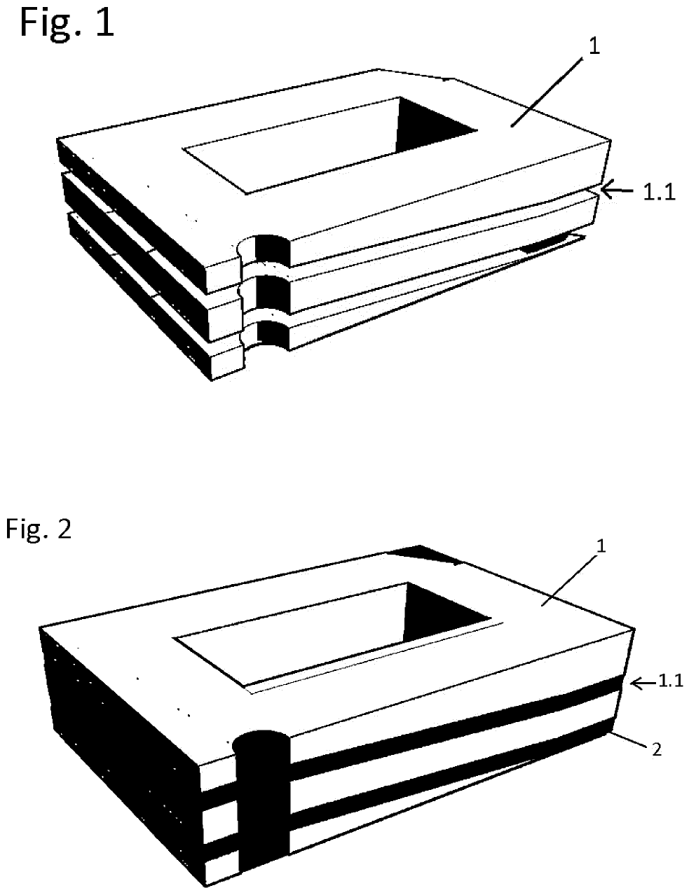

FIG. 1 shows an insert part for use in metal injection molding in an injection molding tool;

FIG. 2 shows an intermediate product, comprising the insert part from FIG. 1 and a green body; and

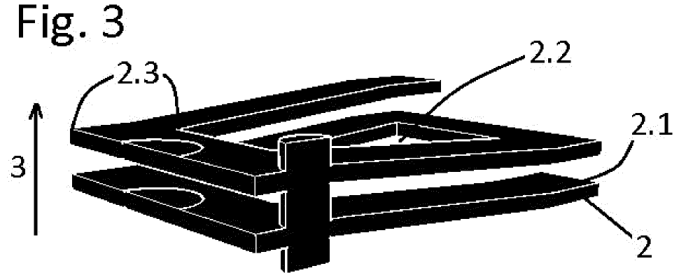

FIG. 3 shows the green body from FIG. 2 after the insert part has been removed.

FIG. 1 shows an insert part 1 according to the application. The insert part 1 has a spiral-shaped cavity 1.1, for producing a coil for an electric motor, for example for a pedelec motor. The insert part 1 is produced in one piece from a thermoset polymer by way of digital light processing. The insert part 1 can be inserted into an injection molding tool (not shown), so that the injection molding tool encloses the insert part 1. Thereafter, a molding compound can be injected into the injection molding tool and into the cavities.

FIG. 2 shows an intermediate product, which comprises the insert part 1 from FIG. 1 and a green body 2 made of a molding compound solidified in the spiral-shaped cavity 1.1. The molding compound comprises a highly conductive copper powder and an elastic organic binder. In other embodiments, the molding compound can also contain a different metal powder, such as steel powder, aluminum powder or titanium powder, or contain powder made of alloys. The intermediate product is removed from the injection molding tool. In a next step, the insert part 1 is removed by being decomposed by way of hydrolysis. An expansion or deformation of the insert part 1 during the decomposition is tolerated due to the elastic organic binder of the molding compound, and, after the insert part 1 has completely decomposed, the green body 2 takes on the shape of the spiral-shaped cavity 1.1 again.

FIG. 3 shows the green body 2 from FIG. 2, wherein the insert part 1 has been removed. The green body 2 has the geometry desired for the molded part. In post-processing steps, undesirable gate structures, edges or burrs can easily be mechanically removed from the green body 2 while it is still relatively easy to process. The organic binder is removed by way of subsequent debinding, and the component is then densified by sintering, whereby the component is given the net shape thereof. By producing the spiral-shaped green body in an injection molding process, the green body can have a rectangular winding cross-sectional profile 2.1 and an angled progression 2.3, which cannot be achieved by winding.

The present application refers, among other things, to the following aspects:
1. A method for producing metallic spirals, comprising the following steps:
   providing a spiral-shaped cavity (1.1) in an injection molding tool;
   filling the cavity (1.1) with a molding compound containing a powder made of a sinterable material;
   producing a green body (2) by solidifying the molding compound;
   removing the green body (2) from the injection molding tool;
   debinding the green body (2);
   sintering the green body (2).
2. The method according to aspect 1, wherein the spiral-shaped cavity (1.1) is formed by a mold of the injection molding tool and/or by one or more insert parts (1).
3. A method according to any one of the preceding aspects, wherein the molding compound contains a steel powder for producing steel springs.
4. A method according to any one of the preceding aspects, wherein the molding compound contains a copper powder for producing copper coils, and preferably high purity copper for producing highly conductive copper coils.
5. A metallic spiral, produced by a method according to any one of the preceding aspects.
6. The metallic spiral according to aspect 5, wherein the spiral is a copper coil or an aluminum coil or a coil made of a copper alloy or of an aluminum alloy.
The metallic spiral according to aspect 5, wherein the spiral is a steel spring.
8. A metallic spiral according to any one of aspects 5 to 7, characterized in that an inner hollow space (2.2) delimited by the windings of the molded spiral has a non-round cross-sectional surface.
9. A metallic spiral according to any one of aspects 5 to 8, characterized in that the inner hollow space (2.2) delimited by the windings of the molded spiral has a variable cross-sectional surface along a longitudinal direction 3 of the coil.
10. A metallic spiral according to any one of aspects 5 to 9, characterized by having a non-round winding cross-sectional profile (2.1).
11. A metallic spiral according to any one of claims 5 to 10, characterized by having a variable winding cross-sectional profile (2.1).
12. A metallic spiral according to any one of aspects 5 to 11, characterized by having a variable pitch and/or winding direction along the longitudinal direction (3).

1-21. (canceled)

22. A method for producing a molded body, comprising the following steps:
producing one or more insert parts;
providing the one or more insert parts in a mold of an injection molding tool so that a cavity corresponding to the shape of the molded body is formed by the one or more insert parts, or by the one or more insert parts together with the mold;
filling the cavity with a molding compound containing a powder made of a sinterable material;
producing a green body by solidifying the molding compound;
removing an intermediate product, comprising the green body and the one or more insert parts, from the injection molding tool;
removing the one insert part or the plurality of insert parts from the intermediate product;
debinding the green body; and
sintering the green body.

23. The method according to claim 22, wherein the method is a metal injection molding method and/or the molding compound comprises a metal powder.

24. The method according to claim 22, wherein the molding compound comprises copper powder, steel powder or aluminum powder.

25. The method according to claim 22, wherein the insert parts are produced from a thermoset polymer, from a thermoplastic polymer, from a thermoplastic composite or from salt.

26. The method according to claim 22, wherein a reactive substance mixture is used to produce the one or more insert parts.

27. The method according to claim 22, wherein the injected molding compound has a temperature between 50° C. and 300° C. including between 100° C. and 250° C., and between 120° C. and 200° C.

28. The method according to claim 22, wherein the one or more insert parts are produced in an additive manufacturing process.

29. The method according to claim 22, wherein insert parts are produced from a thermoset material or from a thermoplastic composite in an additive manufacturing process.

30. The method according to claim 22, wherein the one or more insert parts are produced by way of stereolithography, or direct light processing, or digital light processing, or multijet modeling.

31. The method according to claim 22, wherein the one or more insert parts are produced by way of selective laser sintering, or selective laser melting, or fused deposition modeling or fused filament fabrication.

32. The method according to claim 22, wherein the one or more insert parts are formed of acrylonitrile butadiene styrene (ABS), or polyethylene terephthalate (PET), or polylactide (PLA), or polyvinyl acetate (PVA).

33. The method according to claim 22, wherein the one or more insert parts are formed of a three-dimensionally cross-linked polymer.

34. The method according to claim 22, wherein the one or more insert parts are removed by placing the intermediate product in an aqueous medium so as to dissolve the one or more insert parts, or wherein the one or more insert parts are decomposed by way of catalysis based on an acid or a base, or by way of hydrolysis.

35. The method according to claim 22, wherein the one or more insert parts are chemically removed, by dissolution in a solvent or by way of chemical cleavage of polymers of which the one or more insert parts are formed and dissolution of the decomposition products.

36. The method according to claim 22, wherein the one or more insert parts are produced by way of binder jetting, and the one or more insert parts are removed by dissolving a binder used for the binder jetting in a solvent, or by chemically cleaving the binder in a liquid medium.

37. The method according to claim 22, wherein the cavity is spiral-shaped.

38. The method according to claim 22, wherein the powder-filled molding compound is produced by kneading and/or by extrusion, including by the use of a twin-screw extruder.

39. The method according to claim 22, wherein the one or more insert parts are decomposed during a thermal debinding process by way of burning out.

40. The method according to claim 22, further comprising a step downstream of the removal of the one or more insert parts, in which the green body is mechanically rinsed so as to remove residues of the one insert part or of the multiple insert parts.

41. The method according to claim 22, further comprising a step in which the green body is mechanically post-processed prior to sintering.

42. The method according to claim 22, wherein different insert parts are produced for the same mold to produce molded bodies having different geometries.
